(19) United States
(12) Patent Application Publication
(10) Pub. No.: US 2014/0367366 A1
(43) Pub. Date: Dec. 18, 2014

(54) SYSTEMS AND METHODS OF CONDITIONING AN AIR FLOW FOR A WELDING ENVIRONMENT

(71) Applicant: Hobart Brothers Company, Troy, OH (US)

(72) Inventors: Michael Scott Bertram, Troy, OH (US); Steven Edward Barhorst, Sidney, OH (US)

(21) Appl. No.: 14/298,493

(22) Filed: Jun. 6, 2014

Related U.S. Application Data
(60) Provisional application No. 61/835,323, filed on Jun. 14, 2013.

(51) Int. Cl. B23K 35/38; B23K 9/173; B23K 9/16

(52) U.S. Cl. CPC B23K 35/38; B23K 9/164; B23K 9/173
USPC 219/74

(57) ABSTRACT

A welding system includes a gas supply system configured to provide an air flow to a welding application. The gas supply system is configured to draw the air flow from an ambient environment about the gas supply system.

### CROSS REFERENCE TO RELATED APPLICATIONS

This application claims priority from and the benefit of U.S. Provisional Application Ser. No. 61/835,323, entitled “SYSTEMS AND METHODS FOR CONDITIONING AIR IN A WELDING ENVIRONMENT”, filed Jun. 14, 2013, which is herein incorporated by reference in its entirety for all purposes.

### BACKGROUND

This invention relates generally to arc welding systems, and particularly to arc welding with an air flow.

Arc welding systems generally include a power source that applies electrical current to an electrode so as to pass an arc between the electrode and a work piece, thereby heating the electrode and work piece to create a weld. In many systems, a shielding gas may be introduced or created in and around the welding arc and the weld pool during welding. Shielding gases may reduce atmospheric contamination of the weld that may otherwise affect a weld. For example, inclusion of hydrogen may embrittle and weaken the weld. Hydrogen may be introduced to a weld from moisture in the shielding gas or the electrode. The level of some atmospheric contaminants in the weld may be based on conditions of the ambient environment.

### BRIEF DESCRIPTION

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

In one embodiment, a welding system includes a gas supply system configured to provide an air flow to a welding application. The gas supply system is configured to draw the air flow from an ambient environment about the gas supply system.

In another embodiment, a method for reducing a hydrogen content of a weld includes receiving an air stream from an ambient environment via an inlet of a gas supply system and providing the air stream to a welding application during a welding process.

In another embodiment, a welding system includes a gas supply system having a compressor and a coil. The compressor has an inlet configured to receive an air stream at a first pressure from an ambient environment about the compressor, and an outlet configured to discharge the air stream at a second pressure greater than the first pressure. The coil is coupled to the compressor and to a welding torch. The coil is configured to receive the air stream at the second pressure from the outlet, to remove moisture from the air stream, and to discharge the air stream to the welding torch.

### DRAWINGS

These and other features, aspects, and advantages of the present invention will become better understood when the following detailed description is read with reference to the accompanying drawings in which like characters represent like parts throughout the drawings, wherein:

FIG. 1 is an embodiment of a flux cored arc welding (FCAW) system with a power source, a wire feeder, and a gas supply system;

FIG. 2 is an embodiment of a wire feeder and a gas supply system in a common enclosure;

FIG. 3 is an embodiment of a welding power unit and a gas supply system in a common enclosure; and

FIG. 4 is a flow chart illustrating steps to condition a gas stream provided to a welding torch.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

The embodiments of welding systems described herein may be utilized to reduce an amount of hydrogen in the weld pool. The welding systems described herein may reduce the hydrogen in the weld pool by removing moisture from a gas flow provided to a welding application (e.g., via the torch) alone or in combination with removing moisture from the electrode. The gas flow introduced to the welding application displaces at least a portion of the ambient environment about the weld pool, thereby displacing hydrogen from the ambient environment about the weld pool. The gas flow may be drier (e.g., less moist) than the ambient environment. It should be appreciated that, while the present discussion may specifically discuss gas metal arc welding (GMAW) and flux cored arc welding (FCAW), the welding systems as discussed herein may benefit any arc welding process that seeks to minimize hydrogen concentrations in welds. As such, the gas supply system disclosed herein may provide a gas flow with a reduced hydrogen content for other welding processes, such as tungsten inert gas (TIG) welding, as well as for welding processes that may not typically use a shielding gas (e.g., submerged arc welding (SAW), shielded metal arc welding (SMAW).

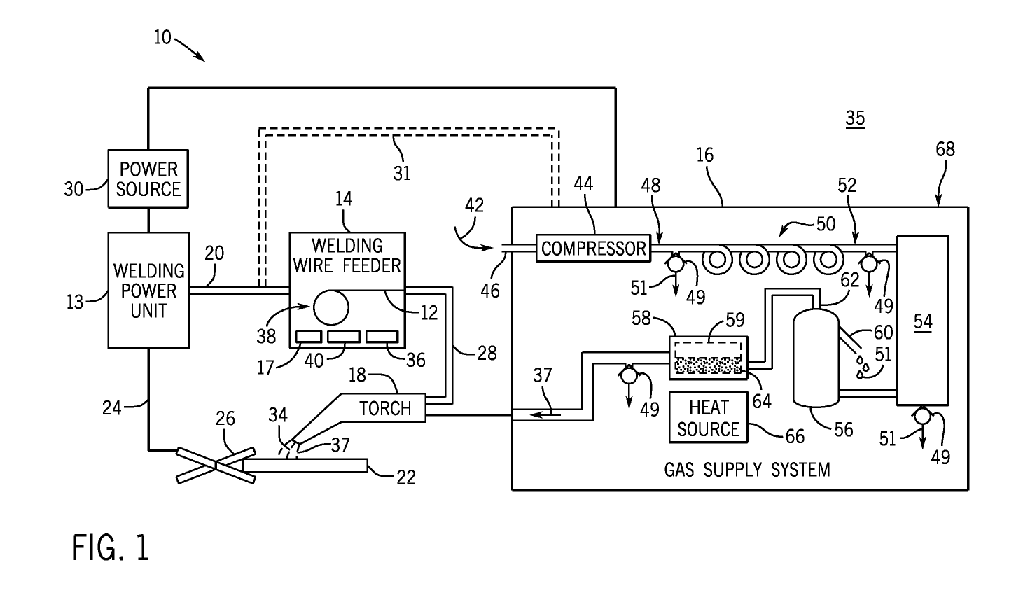

Turning to the figures, FIG. 1 is a block diagram of an embodiment of a flux cored arc welding (FCAW) system 10 that utilizes a tubular welding wire 12, in accordance with the present disclosure. It should be appreciated that, while the present discussion may focus specifically on the FCAW system 10 illustrated in FIG. 1, the presently disclosed hydrogen reduction systems may benefit any arc welding process (e.g., GMAW, GTAW, submerged arc welding (SAW), or similar arc welding process). It should be appreciated that certain welding system embodiments (e.g., SAW welding systems or GTAW welding systems) using the disclosed hydrogen reduction systems may include components not illustrated in the example FCAW system 10 (e.g., a flux hopper, a flux delivery component, a rod welding electrode, etc.) and/or not include components that are illustrated in the example FCAW system 10 (e.g., the gas supply system 16, electrode heat source 17).

The welding system 10 includes a welding power unit 13, a welding wire feeder 14, a gas supply system 16, and a welding torch 18. The welding power unit 13 generally supplies power to the welding system 10 and may be coupled to the welding wire feeder 14 via a cable bundle 20 as well as coupled to a work piece 22 using a lead cable 24 having a clamp 26. In the illustrated embodiment, the welding wire feeder 14 is coupled to the welding torch 18 via a cable bundle 28 in order to supply consumable, tubular welding wire 12 (e.g., the welding electrode) and power to the welding torch 18 during operation of welding system 10. In another embodiment, the welding power unit 13 may couple and directly supply power to the welding torch 18.

The welding power unit 13 may generally include power conversion circuitry that receives input power from an alternating current power source 30 (e.g., an AC power grid, an engine/generator set, or a combination thereof), conditions the input power, and provides DC or AC output power via the cable 20. As such, the welding power unit 13 may power the welding wire feeder 14 that, in turn, powers the welding torch 18, in accordance with demands of the welding system 10. As illustrated by the dashed line 31, the welding power unit 13 may power the gas supply system 16. For example, the welding power unit 13 may power the gas supply system 16 via output power (e.g., weld power) provided along the cable 20. Additionally, or in the alternative, the power source 30 may directly power the gas supply system 16. The lead cable 24 from the welding power unit 13 terminating in the clamp 26 couples the welding power unit 13 to the work piece 22 to close the circuit between the welding power unit 13, the work piece 22, and the welding torch 18 during weld formation. The welding power unit 13 may include circuit elements (e.g., transformers, rectifiers, switches, and so forth) capable of converting the AC input power to a direct current electrode positive (DCEP) output, direct current electrode negative (DCEN) output, DC variable polarity, or a variable balance (e.g., balanced or unbalanced) AC output, as dictated by the demands of the welding system 10.

The welding wire feeder 14 also includes components for feeding the tubular welding wire 12 to the welding torch 18, and thereby to the welding application, under the control of a controller 36. For example, in certain embodiments, one or more wire supplies (e.g., a wire spool 38) of tubular welding wire 12 may be housed in the welding wire feeder 14. A wire feeder drive unit 40 may unspool the tubular welding wire 12 from the spool 38 and progressively feed the tubular welding wire 12 to the welding torch 18. To that end, the wire feeder drive unit 40 may include components such as circuitry, motors, rollers, and so forth, configured in a suitable way for establishing an appropriate wire feed. For example, in one embodiment, the wire feeder drive unit 40 may include a feed motor that engages with feed rollers to push wire from the welding wire feeder 14 towards the welding torch 18. Additionally, power from the welding power unit 13 may be applied to the fed wire. In some embodiments, the electrode heat source 17 may heat the tubular welding wire 12 to evaporate any moisture within the tubular welding wire 12, thereby reducing the hydrogen content of the tubular welding wire 12. The electrode heat source 17 may include, but is not limited, to a resistive heater, an induction heater, a peltier device, or a flame, or any combination thereof.

The illustrated welding system 10 includes a gas supply system 16 (e.g., air supply system) that supplies an air flow 37 to a welding application (e.g., the welding torch 18). In the depicted embodiment, the gas supply system 16 is directly coupled to the welding torch 18 via a gas conduit 32. In other embodiments, the gas supply system 16 may instead be coupled to the wire feeder 14, and the wire feeder 14 may regulate the flow of gas from the gas supply system 16 to the welding torch 18. Additionally, or in the alternative, the gas supply system 16 may be integrated with the welding power unit 13 or the welding wire feeder 14. The air flow 37 provided by the gas supply system 16 to the welding application displaces at least a portion of the ambient environment about the arc 34. As the ambient environment about the arc 34 may contain moisture, displacing at least a portion of the ambient environment about the arc 34 reduces the moisture and hydrogen that may be proximate to the arc 34 and the weld pool. As such, the air flow 37 at least partially clears the environment about the arc 34 and the weld pool. The air flow 37 may serve as a shielding gas for a welding application, such as a FCAW application that may not otherwise receive a shielding gas. A shielding gas, as used herein, may refer to any gas or mixture of gases that may be provided to the arc and/or weld pool in order to provide a particular local atmosphere (e.g., shield the arc, improve arc stability, limit the formation of metal oxides, improve wetting of the metal surfaces, alter the chemistry of the weld deposit, clean the weld pool, and so forth). In certain embodiments, the shielding gas flow may be a shielding gas or shielding gas mixture (e.g., argon (Ar), helium (He), carbon dioxide (CO₂), oxygen (O₂), nitrogen (N₂), similar suitable shielding gases, or any mixtures thereof). In some embodiments, the air flow 37 may be utilized as a shielding gas. Additionally, or in the alternative, the air flow 37 may be utilized in addition to a shielding gas or a shielding gas mixture. Furthermore, the air flow 37 may be a part of a shielding gas provided to a welding application. For example, the air flow 37 (e.g., delivered via the conduit 32) may include ambient air (e.g., N, O, Ar, CO₂), Ar, Ar/CO₂ mixtures, Ar/CO₂/O₂ mixtures, Ar/He mixtures, and so forth. In some embodiments, the air flow 37 includes a compressed air stream 42 with a reduced moisture content and a conventional shielding gas (e.g., Ar, Ar/CO₂ mixtures, Ar/CO₂/O₂ mixtures, Ar/He mixtures, and so forth).

Accordingly, the illustrated welding torch 18 generally receives the welding electrode (i.e., the welding wire), power from the welding wire feeder 14, and an air flow 37 from the gas supply system 16 in order to perform FCAW of the work piece 22. During operation, the welding torch 18 may be brought near the work piece 22 so that an arc 34 may be formed between the consumable welding electrode (e.g., the tubular welding wire 12 exiting a contact tip of the welding torch 18) and the work piece 22. As discussed below, by controlling the composition of the air flow 37, the chemistry of the arc 34 and/or the resulting weld (e.g., composition and physical characteristics) may be tuned. Additionally, or in the alternative, heating the tubular welding wire 12 prior to providing the tubular welding wire 12 to the welding torch 18 may affect the chemistry of the arc 34 and/or the resulting weld. For example, the reducing the moisture of the air flow 37 and/or reducing the moisture of the tubular welding wire 12 may reduce the hydrogen content in the resulting weld, thereby increasing a strength of the weld. For example, the gas supply system 16 may reduce the moisture content of the air flow 37, thereby enabling the welding process to form welds having less than 7, 6, 5, 4, 3, 2, or 1 mL of hydrogen per 100 grams of the welded metal. Furthermore, heating the tubular welding wire 12 to temperatures between approximately 93 to 815 degrees C. for approximately 2 to 8 hours prior to provision to the welding torch 18 may reduce the hydrogen content by approximately 15% relative to unheated tubular welding wire 12.

The gas supply system 16 may reduce a hydrogen content of the air flow 37 provided to the welding torch 18 via one or more gas conditioning components described below. In some embodiments, the gas supply system 16 conditions an air stream 42 from the ambient environment 35 to provide as the air flow 37. The gas supply system 16 may provide the air flow 37 to the welding torch 18 at rates between approximately 20 to 100 ft³/hr, approximately 30 to 80 ft³/hr, or approximately 40 to 60 ft³/hr. A compressor 44 increases the pressure of the air stream 42 from a first pressure (e.g., atmospheric pressure, approximately 101 kPa) to a second pressure between approximately 150 to 500 kPa, approximately 200 to 400 kPa, or approximately 250 to 350 kPa. The compressor 44 receives the air stream 42 through an inlet 46 and discharges the compressed air stream 42 through an outlet 48. Additionally, or in the alternative, the gas supply system 16 may receive the air stream 42 from a reservoir (e.g., bottle, tank, cylinder) of pressurized air. The air stream 42 from the reservoir of pressurized air may have less moisture and a lower dew point than the ambient environment 35. In some embodiments, the outlet 48 is directly coupled to the welding torch 18, thereby providing the compressed air stream 42 as the air flow 37 to the welding torch 18. In some embodiments, the compressed air stream 42 may be provided to the welding torch 18 as a secondary shielding gas in addition to a primary shielding gas (e.g., Ar, Ar/CO₂ mixtures, Ar/CO₂/O₂ mixtures, Ar/He mixtures). As a secondary shielding gas, the compressed air stream 42 may be supplied about the arc 34 and the primary shielding gas to reduce the hydrogen content of the weld. For example, the air flow 37 with a reduced moisture content relative to the ambient environment 35 may reduce the hydrogen content of the weld relative to performing the weld in the ambient environment 35 without the air flow 37.

The compressor 44 may include, but is not limited to a diaphragm-type compressor, a reciprocating compressor, a screw compressor, a scroll compressor, squirrel cage-type compressor, a turbine, a blower, a pump, and a fan, among others. As may be appreciated, compressing the air stream 42 increases the temperature and may increase the relative humidity of the air stream 42. In some embodiments, the compressor 44 compresses the air stream 42 to a second pressure that condenses at least a portion of the moisture in the air stream 42, thereby enabling the condensed moisture to be removed from the air stream 42 via a gas conditioning component (e.g., check valve, drain, filter, separator) downstream of the compressor 44. The outlet 48 may have a check valve 49 or drain configured to remove the condensed moisture 51 from the compressed air stream 42. Increasing the second pressure may increase the amount of the condensed moisture 51 from the compressed air stream 42, thereby facilitating removal of the additional moisture from the air stream 42.

A coil 50 may be coupled to the outlet 48 to condition the compressed air stream 42. For example, the coil 50 may cool the compressed air stream 42. In some embodiments, the coil 50 is a heat exchanger coil that transfers heat from the compressed air stream 42 to the ambient environment 35. In some embodiments, the coil 50 includes a peltier device or a heat pump configured to cool the compressed air stream 42. Additionally, or in the alternative, the coil 50 may be air-cooled. The coil 50 may facilitate cooling the compressed air stream 42 to approximately the temperature of the ambient environment. Cooling the compressed air stream 42 enables additional moisture in the compressed air stream 42 to condense, thereby enabling the condensed moisture 51 to be removed from the air stream 42. The material of the coil 50 may include, but is not limited, to copper, aluminum, steel, brass, or any combination thereof. The coil 50 may have a drain and/or a check valve 49 coupled to a downstream end 52 of the coil 50, where the drain and/or the check valve 49 is configured to remove the condensed moisture 51 from the compressed air stream 42.

The downstream end 52 of the coil 50 may direct the compressed air stream 42 to the welding torch 18 directly, or to one or more additional gas conditioning components, such as a reservoir 54 (e.g., tank), a separator 56 (e.g., centrifugal moisture separator), a filter 58, or any combination thereof. The reservoir 54 may store a volume of the compressed air stream 42 with a reduced moisture content, and therefore a reduced hydrogen content, relative to the ambient environment 35. The volume of the reservoir 54 may enable the compressor 44 to provide the compressed air stream 42 to the coil 50 independent from when the gas supply system 16 is providing an air flow 37 to the welding torch 18. That is, the reservoir 54 enables the operation of the compressor 44 to be decoupled from the operation of the welding torch 18 so that the compressor 44 is not required to provide the air flow 37 on-demand. However, in some embodiments the compressor 44 is configured to provide the compressed air stream 42 to the welding torch 18 on-demand as the air flow 37. A check valve 49 and/or a drain may facilitate the removal of condensed moisture 51 from the reservoir 54.

Embodiments of the gas supply system 16 with the separator 56 may direct the compressed air stream 42 in a vortex, thereby separating at least a portion of the moisture of the compressed air stream 42. The vortex drives at least a portion of the moisture of the compressed air stream 42 radially outward toward a first port 60 (e.g., drain), while a less dense, drier portion of the compressed air stream 42 that remains is directed to a second port 62. Accordingly, a moist air portion of the compressed air stream 42 exits the separator 56 through the first port 60, and a dry air portion of the compressed air stream 42 exits the separator 56 through the second port 62, thereby reducing the moisture of the compressed air stream 42.

The filter 58 may remove moisture and/or particulates from the compressed air stream 42. Some embodiments of the gas supply system 16 may utilize one or more filters 58 alone or in combination with other air stream conditioning components. The one or more filters 58 may include various types of filters, such as a desiccant filter, molecular sieve, a coalescing filter, or any combination thereof. The one or more filters 58 may have a cartridge 59 that may be readily replaced during a maintenance period. As may be appreciated, a desiccant filter absorbs moisture, and a molecular sieve adsorbs moisture and/or particulates. Materials for a desiccant bed 64 of a desiccant filter may include, but are not limited, to calcium sulfate, activated alumina, silica gel, or any combination thereof. A desiccant bed 64 may enable the air flow 37 to have a dew point less than approximately 0, −10, −20, −30, −40, −50, or −75 degrees C. In some embodiments, the material of the desiccant bed 64 may be replaced via a replacement cartridge 59, such as when the moisture content of the desiccant bed 64 is above a predefined threshold (e.g., approximately 25, 50, 75 or 90 percent saturated). A saturated desiccant cartridge 59 may be regenerated via heating and/or exposure to a relatively dry air source. Additionally, or in the alternative, a heat source 66 (e.g., resistance heater, induction heater, flame) may heat at least a portion of the desiccant bed 64 and/or the cartridge 59 to regenerate the desiccant bed 64 while installed in the gas supply system 16. Moisture released from heating the desiccant bed 64 may be released to the ambient environment 35 via a check valve. In some embodiments, the filter 58 with the desiccant bed 64 may positively pressurized to reduce or eliminate air from the ambient environment entering the filter 58 directly. A coalescing filter may be a membrane-type filter or a micro-fiber filter that facilitates condensing of moisture from the compressed air stream 42, removal of oils or lubricants from the compressed air stream 42, or adsorption of moisture and/or particulates, or any combination thereof. A membrane filter may enable the air flow 37 to have a dew point less than approximately 0, −10, −20, −30, or −40 degrees C. In some embodiments, a cartridge 59 (e.g., membrane, micro-fiber filter element) of the coalescing filter may be replaced after an operational duration of approximately 6 months, 1 year, 2 years, 5 years, or 10 years or more. A micro-fiber filter cartridge may enable removal of particulates and/or water droplets larger than approximately 0.01, 0.05, or 0.1 microns.

Embodiments of the gas supply system 16 may include one or more check valves 49, one or more drains (e.g., port 60), or any combination thereof to remove condensed moisture 51 from the compressed air stream 42. It may be appreciated that the drains and check valves discussed above may be manually actuated or automatically actuated. For example, a drain may be configured to automatically actuate to remove condensed moisture from a gas conditioning component (e.g., compressor 44, coil 50, reservoir 54, separator 56, filter 58) prior to providing the compressed air stream 42 as the air flow 37, when the compressor 44 has operated for a predefined duration, or when a predefined volume of the air flow 37 has been supplied to the welding torch 18. Additionally, or in the alternative, a check valve 49 may release condensed moisture 51 when the condensed moisture 51 increases above a predefined threshold.

As discussed above, the gas conditioning components of the gas supply system 16 facilitate reducing the moisture content, and therefore reducing the hydrogen content, from the air flow 37 provided to the welding application (e.g., welding torch 18). The gas supply system 16 may utilize various configurations of the gas conditioning components based at least in part on the desired moisture content of the air flow 37. For example, some embodiments of the gas supply system 16 may have only the compressor 44 and one or more check valves 49 or drains to remove condensed moisture 51. Compressing an air stream at approximately 32 degrees C. and 80% relative humidity from 101 kPa to approximately 414 kPa and removing the condensed moisture may remove approximately 60% of the original moisture from the air stream. Cooling the compressed air stream 42 via the coil 50 and/or the reservoir 54 may facilitate further moisture reduction of the compressed air stream 42.

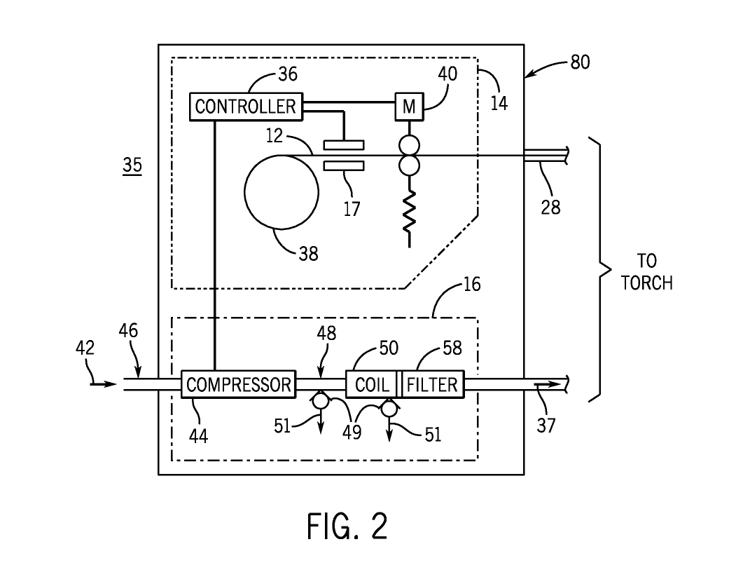

The gas supply system 16 may be utilized with the other components (e.g., welding power unit 13, welding wire feeder 14) of the welding system 10 in various configurations. For example, FIG. 1 illustrates the gas supply system 16 disposed in a gas supply enclosure 68 separate from the welding power unit 13 and the welding wire feeder 14. FIG. 2 illustrates an embodiment of the gas supply system 16 disposed within a common enclosure 80 with the welding wire feeder 14. The common enclosure 80 may reduce the quantity of distinct components of the welding system 10. The common enclosure 80 may be a bench-type wire feeder that may be mounted to a work site or a cart. In some embodiments, the common enclosure 80 may be a suit-case type wire feeder that may be carried or readily moved by the operator, thereby increasing the flexibility and mobility of the gas supply system 16. The controller 36 may be configured to control operation of the welding wire feeder 14 and the gas supply system 16. For example, the controller 36 controls the wire feed drive 40 (e.g., motor) that provides the welding wire 12 (e.g., tubular welding wire) to the welding torch 18. In some embodiments, the controller 36 controls the heat source 17 (e.g., resistance heater, induction heater, flame) to heat the welding wire 12. The heat source 17 may heat the spool 38 of welding wire, the welding wire 12 as it is provided to the welding torch 18, or any combination thereof. Heating the welding wire 12 may facilitate evaporation of moisture that may have condensed or been absorbed by the welding wire 12.

The controller 36 controls the compressor 44 of the gas supply system 16. For example, the controller 36 may control the flow rate, the second pressure of the compressed air stream 42, and the actuation of one or more check valves that release condensed moisture 51 from the gas supply system 16. As discussed above, the compressor 44 compresses the air stream 42 from the first pressure of the ambient environment 35 to the second pressure. Compressing the air stream 42 may increase the temperature and may increase the relative humidity of the air stream 42. The amount of condensed moisture that may be removed from the compressed air stream 42 at the outlet 48 may be directly related to the difference between the first pressure and the second pressure. For example, increasing the second pressure may increase the condensed moisture that may be removed from the compressed air stream 42 at the outlet 48, and decreasing the second pressure may decrease the condensed moisture that may be removed from the compressed air stream at the outlet 48. In some embodiments, the compressor 44 causes the air stream 42 to become saturated such that at least a portion of the moisture in the compressed air stream 42 condenses. The condensed moisture may be removed at the outlet 48. The coil 50 enables the compressed air stream 42 at the second pressure to be cooled, such as to approximately the temperature of the ambient environment. Cooling the compressed air stream 42 increases the relative humidity of the compressed air stream 42, thereby facilitating condensation and removal of additional condensed moisture 51 from the compressed air stream 42 via the check valve 49, drain, or filter 58, or any combination thereof. In some embodiments, the filter 58 filters the compressed air stream 42 before the compressed air stream 42 is provided to the welding torch 18 as the air flow 37. The filter 58 may be a desiccant filter or a membrane filter configured to remove additional moisture from the compressed air stream 42. In some embodiments, the filter 58 removes particulates from the compressed air stream.

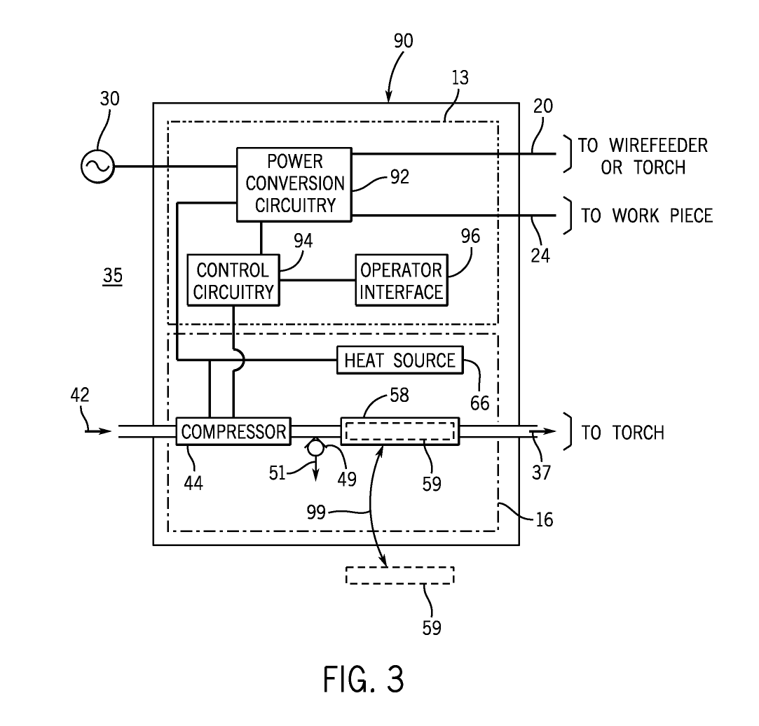

FIG. 3 illustrates an embodiment of the gas supply system 16 disposed within a common enclosure 90 with the welding power unit 13. The common enclosure 90 may reduce the quantity of distinct components of the welding system 10. The welding power unit 13 is coupled to and receives input power from the power source 30. Power conversion circuitry 92 of the welding power unit 13 converts the received input power to output power suitable for a welding process, for driving the welding wire feeder 14, for driving auxiliary devices (e.g., lights, power tools, heaters), or for driving the compressor 44 of the gas supply system 16, or any combination thereof. Control circuitry 94 controls the power conversion circuitry 92. For example, the control circuitry 94 may control the voltage, the current, the polarity, and the frequency of the output power from the power conversion circuitry 92. The power conversion circuitry 92 may include, but is not limited to, a boost converter, a buck converter, a bus capacitor, a transformer, a rectifier, or any combination thereof. The power conversion circuitry 92 may be configured to provide output power as a constant voltage source, a constant current source, or both. Moreover, the power conversion circuitry 92 may be configured to provide output power for one or more welding processes (e.g., FWAC, GMAW, TIG, SMAW, SAW). The control circuitry 94 may control the power conversion circuitry 92 based at least in part on input received via an operator interface 96, process control data stored in a memory, or any combination thereof.

The control circuitry 94 may control the compressor 44 of the gas supply system 16. For example, the controller 36 may control the flow rate, the second pressure of the compressed air stream 42, and the actuation of one or more check valves 49 that release condensed moisture 51 from the gas supply system 16. As discussed above, the compressor 44 compresses the air stream 42 from the first pressure of the ambient environment 35 to the second pressure. In some embodiments, the compressor 44 causes the air stream 42 to become saturated such that at least a portion of the moisture in the compressed air stream 42 condenses. The condensed moisture 51 may be removed at the outlet 48. After the condensed moisture 51 is removed from the compressed air stream, the filter 58 filters the compressed air stream 42 before the compressed air stream 42 is provided to the welding torch 18 as the air flow 37. The filter 58 may have a cartridge 59 that may be replaced, as shown by the arrow 99. The cartridge 59 may be a desiccant filter configured to remove additional moisture from the compressed air stream 42. The heat source 66 may be coupled to or near the filter 58. The heat source 66 may heat at least a portion of the cartridge 59, thereby recharging the cartridge by removing absorbed moisture. That is, the heat source 66 may recharge the cartridge 59 (e.g., desiccant media 64) by drying the cartridge 59. In some embodiments, the filter 58 removes particulates from the compressed air stream.

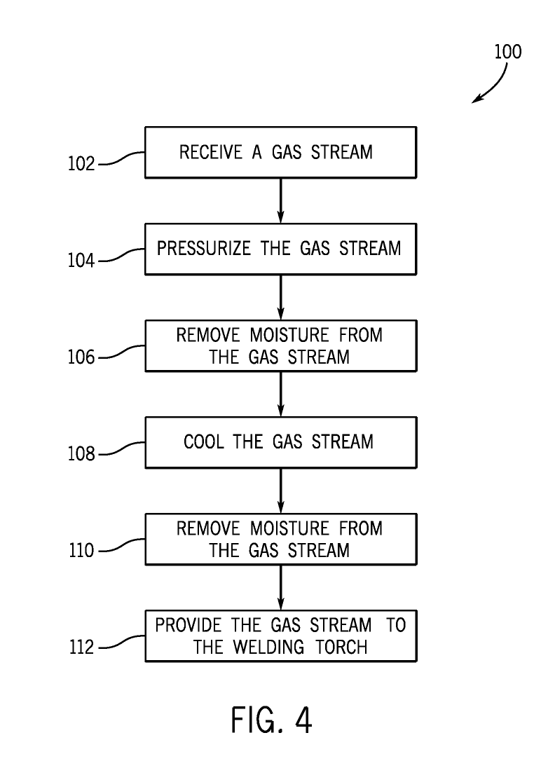

FIG. 4 illustrates a method 100 for reducing a hydrogen content of a weld by conditioning a gas stream with the gas supply system. The gas supply system receives (block 102) a gas stream. The gas stream may be an air stream from the ambient environment about the gas supply system or an air stream from a reservoir (e.g., tank, cylinder, or bottle). In some embodiments, the gas stream includes a shielding gas or a shielding gas mixture, such as Ar, Ar/CO₂ mixtures, Ar/CO₂/O₂ mixtures, Ar/He mixtures, and so forth. The gas supply system pressurizes (block 104) the gas stream, thereby facilitating the condensation of moisture in the gas stream. The gas supply system removes (block 106) moisture from the gas stream as described above, such as via a check valve, a drain, a separator, or a coalescing filter, or any combination thereof. The gas supply system may cool (block 108) the compressed gas stream, thereby increasing the relative humidity of the compressed gas stream and enabling additional moisture to be readily removed from the compressed gas stream. The gas supply system may again remove (block 110) moisture from the gas stream, such as via a check valve, a drain, a separator, or a coalescing filter, or any combination thereof. The gas supply system then provides (block 112) the gas stream to the welding torch.

Reducing the moisture of the air flow provided to the torch reduces the hydrogen present in the arc during weld formation, thereby reducing the hydrogen content in the weld. Accordingly, a gas flow with a reduced moisture content may facilitate weld formation with less than approximately than 7, 6, 5, 4, 3, 2, or 1 mL of hydrogen per 100 grams of the welded metal. This decreased hydrogen content in the welded metal decreases hydrogen embrittlement and increases the strength of the weld. Moreover, the air flow may displace other gases or particulates in the environment about the arc and the weld pool.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A welding system comprising:
a gas supply system configured to provide an air flow to a welding application, wherein the gas supply system is configured to draw the air flow from an ambient environment about the gas supply system.

2. The system of claim 1, wherein the gas supply system comprises:
a compressor comprising an inlet configured to receive the air flow at a first pressure of the ambient environment and an outlet configured to discharge the air flow at a second pressure greater than the first pressure.

3. The system of claim 2, wherein the gas supply system comprises a coil coupled to the compressor, wherein the coil is configured to receive the air flow at the second pressure from the outlet, to remove moisture from the air flow, and to discharge the air flow to a welding torch.

4. The system of claim 3, wherein the coil is configured to remove moisture from the air flow via at least one of a coalescing filter and a drain.

5. The system of claim 3, wherein the coil comprises a heat exchanger configured to cool the air flow at the second pressure to a first temperature less than or equal to a second temperature of the ambient environment.

6. The system of claim 1, wherein a first hydrogen content of the air flow is equal to or less than a second hydrogen content of the ambient environment.

7. The system of claim 1, wherein the gas supply system comprises a desiccant media configured to absorb moisture from the air flow.

8. The system of claim 7, wherein the gas supply system comprises a heat source coupled to the desiccant media, wherein the heat source is configured to recharge the desiccant media.

9. The system of claim 1, wherein the gas supply system comprises a centrifugal moisture separator configured to reduce a moisture content of the air flow.

10. The system of claim 1, comprising:
a wire feeder configured to provide a welding wire to a welding torch; and
an enclosure configured to house the wire feeder and the gas supply system.

11. The system of claim 10, comprising a heat source configured to reduce a hydrogen content of the welding wire by heating the welding wire.

12. The system of claim 10, comprising:
a welding power source coupled to the wire feeder and to the gas supply system, wherein the welding power source is configured to provide output power to the wire feeder and to the gas supply system, and to provide welding output to the welding torch; and
the welding torch configured to receive the welding output, the welding wire, and the air flow, wherein the welding wire comprises a tubular welding wire.

13. A method for reducing a hydrogen content of a weld, comprising:
receiving an air stream from an ambient environment via an inlet of a gas supply system; and
providing the air stream to a welding application during a welding process.

14. The method of claim 13, comprising reducing a hydrogen content of the air stream, wherein reducing the hydrogen content of the air stream comprises compressing the air stream to a first pressure greater than a second pressure of the ambient environment and removing moisture from the air stream.

15. The method of claim 14, wherein removing moisture from the air stream comprises directing the air stream through a coalescing filter or a desiccant media.

16. The method of claim 14, comprising cooling the air stream prior to providing the air stream to the welding application.

17. A welding system comprising:
a gas supply system, comprising:
a compressor comprising an inlet and an outlet, wherein the inlet is configured to receive an air stream at a first pressure from an ambient environment about the compressor, and the outlet is configured to discharge the air stream at a second pressure greater than the first pressure; and
a coil coupled to the compressor and to a welding torch, wherein the coil is configured to receive the air stream at the second pressure from the outlet, to remove moisture from the air stream, and to discharge the air stream to the welding torch.

18. The welding system of claim 17, wherein the coil comprises a heat exchanger configured to cool the air stream and a filter configured to remove moisture from the air stream.

19. The welding system of claim 18, wherein the filter comprises at least one of a coalescing filter and a desiccant media.

20. The welding system of claim 17, comprising:
a wire feeder configured to provide a welding wire to the welding torch; and
an enclosure configured to house the wire feeder, the compressor, and the coil.

21. The welding system of claim 20, comprising a heat source configured to heat the welding wire, wherein heating the welding wire reduces a hydrogen content of the welding wire.
